(19) United States
(12) Patent Application Publication
(10) Pub. No.: US 2020/0292967 A1
(43) Pub. Date: Sep. 17, 2020

(54) IMAGE FORMING APPARATUS

(71) Applicant: Konica Minolta, Inc., Tokyo (JP)

(72) Inventors: Kazutoshi KOBAYASHI, Toyokawa-shi (JP); Junji MURAUCHI, Toyokawa-shi (JP); Ryoei IKARI, Tokorozawa-shi (JP); Shunichi TAKAYA, Tokyo (JP); Kei YUASA, Hino-shi, Tokyo (JP)

(21) Appl. No.: 16/818,215

(22) Filed: Mar. 13, 2020

(30) Foreign Application Priority Data
Mar. 14, 2019 (JP) 2019-046727

(51) Int. Cl. G03G 15/095

(52) U.S. Cl. CPC G03G 15/095

(57) ABSTRACT

An image forming apparatus includes an image carrier that carries a toner image, a developer that develops a toner image on the image carrier, with a developing agent containing toner and carrier, a transferor that transfers the toner image being carried by the image carrier, a collection mechanism that collects the carrier on the image carrier by a magnetic force and an electrostatic force, and a hardware processor that controls removal of the toner adhering to the collection mechanism. The collection mechanism includes a collection roller that incorporates a magnet and that is rotatable while facing the image carrier, and a voltage applicator that applies a voltage to the collection roller. The hardware processor performs a toner removal mode to remove the toner, by setting a peripheral speed of at least one of the image carrier and the collection roller to less than a peripheral speed thereof for image formation.

### CROSS-REFERENCE TO RELATED APPLICATIONS

The present invention claims priority under 35 U.S.C. § 119 to Japanese Application No. 2019-046727 filed on Mar. 14, 2019, the entire content of which is incorporated herein by reference.

### BACKGROUND

### Technological Field

The present invention relates to an image forming apparatus.

### Description of the Related Art

A widely used image forming apparatus includes a developing device that develops an electrostatic latent image formed on a photoconductor drum by using a two-component developing agent containing toner and magnetic carrier.

Specifically, toner in the developing device adheres to carrier through the action of an electric field and a magnetic field, and is transported to a developing area between the developing device and a photoconductor drum. Then, the toner is electrostatically transferred to the surface of the photoconductor drum. Meanwhile, the carrier is collected into the developing device, in which toner adheres to the carrier again. However, part of the carrier is transferred to the surface of the photoconductor drum. Especially, since the resistance value of the carrier decreases due to wear of the surface coating thereof over time, the carrier easily adheres to the photoconductor drum due to charge injection by a developing bias.

When the carrier adheres to the photoconductor drum, leak may occur in response to a transfer voltage applied in a transfer section between the photoconductor drum and the intermediate transfer belt. The leak in the transfer section leaves a mark of the leak on the surface of the photoconductor drum, resulting in black spot image defects. The carrier having passed through the transfer section is caught between the photoconductor drum and a cleaning blade that cleans the surface of the photoconductor drum, and damages the surface of the photoconductor drum and the edge of the cleaning blade.

To address these problems, there are known devices that include a collection mechanism for collecting carrier adhering to a photoconductor drum. For example, there is disclosed an image forming apparatus that brings a collection roller having a magnet therein into contact with the surface of a photoconductor drum, and applies a voltage to the collection roller, thereby transferring the carrier adhering to the photoconductor drum to the collection roller, by the action of an electric field and a magnetic field. There is also disclosed a method wherein a collection roller and a carrier detector are disposed on the downstream side of a developing device so as to prompt replacement of a developing agent or to change a developing bias, in response to a detection of adhesion of carrier to the surface of a photoconductor drum, thereby reducing adhesion of carrier (see, for example, Japanese Patent Application Publications No. 11-237788 and No. 10-326047).

### SUMMARY

A collection roller collects weakly charged/reversely charged toner as well, due to an electric field for collecting carrier. If the toner accumulates on the surface of the collection roller and fills up the clearance between the photoconductor drum and the collection roller, the toner adheres again to the photoconductor drum, resulting in smearing of the image. Accordingly, it is necessary to appropriately remove the toner on the surface of the collection roller, and prevent smearing of the image.

It is therefore an object of the present invention to provide an image forming apparatus including a collection mechanism that collects carrier on a photoconductor drum, wherein toner adhering to the collection mechanism is appropriately removed.

To achieve at least one of the abovementioned objects, an image forming apparatus reflecting one aspect of the present invention includes:

an image carrier that carries a toner image to be transferred to a sheet;

a developer that develops a toner image on the image carrier, with a two-component developing agent containing toner and carrier;

a transferor that transfers the toner image being carried by the image carrier;

a collection mechanism that is disposed on a downstream side of the developer and on an upstream side of the transferor, and collects the carrier on a surface of the image carrier by a magnetic force and an electrostatic force; and

a hardware processor that controls removal of the toner adhering to the collection mechanism;

wherein the collection mechanism includes a collection roller that incorporates a magnet and that is rotatable about an axis parallel to an axis of the image carrier while facing the image carrier, and a voltage applicator that applies a voltage to the collection roller; and

wherein the hardware processor performs a toner removal mode to remove the toner from a surface of the collection roller, by setting a peripheral speed of at least one of the image carrier and the collection roller to less than a peripheral speed thereof for image formation.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 illustrates the schematic configuration of an image forming apparatus according to an embodiment of the present invention;

FIG. 2 is a block diagram illustrating the functional configuration of the image forming apparatus;

FIG. 3 illustrates the schematic configuration of a collection mechanism;

FIG. 4 illustrates the charged state of toner;

FIG. 5 illustrates the relationship between the voltage applied to a collection roller and the toner removal efficiency;

FIG. 6 illustrates the relationship between the voltage applied to the collection roller and the toner removal efficiency;

FIG. 7 illustrates the relationship between the voltage applied to the collection roller and the toner removal efficiency;

FIG. 8 illustrates the relationship between the rotational speeds of the collection roller and the photoconductor drum and the toner removal efficiency;

FIGS. 9A and 9B illustrate the mechanism of toner removal;

FIG. 10 illustrates operation conditions in a toner removal mode;

FIG. 11 illustrates the relationship between the charge amount of toner and the amount of toner adhering;

FIG. 12 illustrates changes in amount of toner adhering in response to execution of the toner removal mode;

FIG. 13 is a flowchart illustrating the operations of the image forming apparatus; and

FIG. 14 is a flowchart illustrating the operations of the image forming apparatus in the toner removal mode.

### DETAILED DESCRIPTION OF THE EMBODIMENTS

Hereinafter, embodiments of an image forming apparatus according to the present invention will be described with reference to the accompanying drawings. However, the scope of the invention is not limited to the disclosed embodiments.

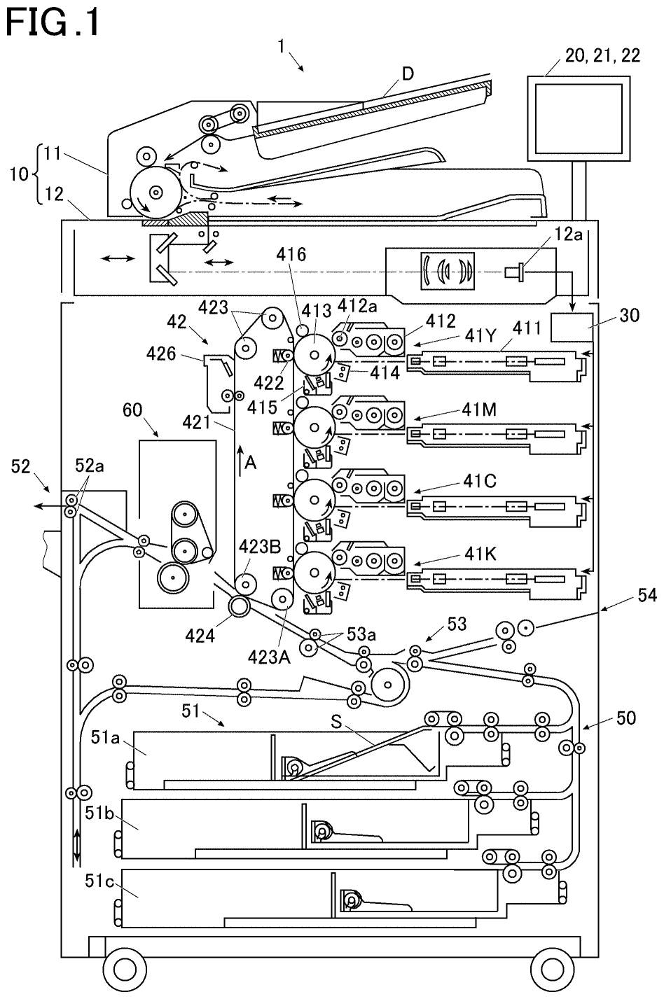

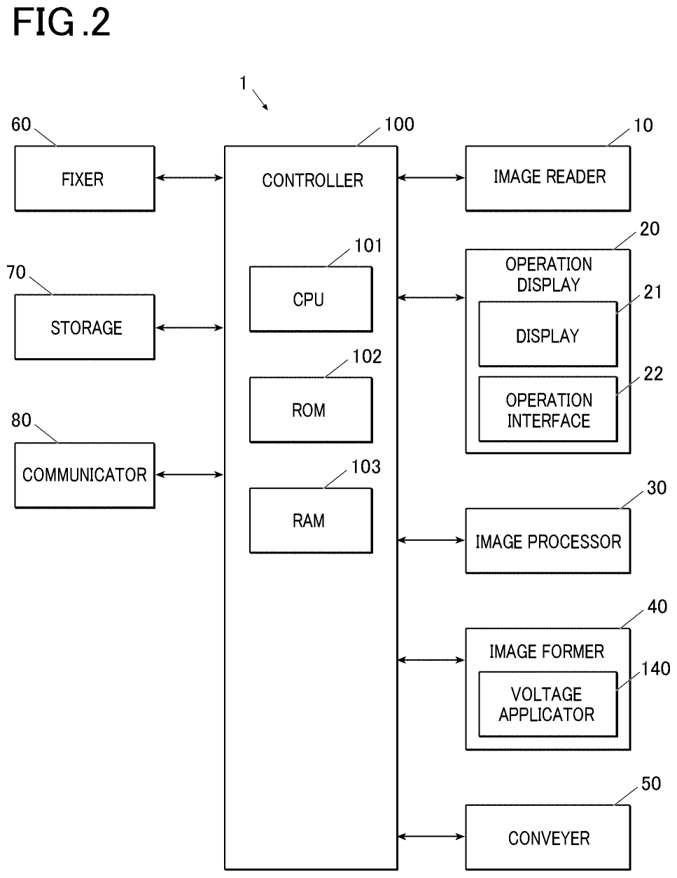

FIG. 1 is a schematic diagram illustrating the overall configuration of an image forming apparatus 1 according to an embodiment. FIG. 2 is a block diagram illustrating the main functional configuration of the image forming apparatus 1 according to the present embodiment. The image forming apparatus 1 illustrated in FIGS. 1 and 2 is an intermediate transfer type color image forming apparatus using an electrophotographic process technology. That is, the image forming apparatus 1 transfers (primary-transfers) toner images of respective colors of yellow (Y), magenta (M), cyan (C), and black (K) formed on photoconductor drums 413 to an intermediate transfer belt 421 such that the toner images of the four colors are superimposed on one another on the intermediate transfer belt 421. Then, the image forming apparatus 1 transfers (secondary-transfers) the resultant image to a sheet S, thereby forming an image.

The image forming apparatus 1 employs a tandem system in which the photoconductor drums 413 corresponding to the four colors of YMCK are disposed in series in a traveling direction of the intermediate transfer belt 421, and toner images of respective colors are sequentially transferred to the intermediate transfer belt 421.

As illustrated in FIG. 2, the image forming apparatus 1 includes an image reader 10, an operation display 20, an image processor 30, an image former 40, a conveyer 50, a fixer 60, a storage 70, a communicator 80, and a controller 100 (hardware processor).

The controller 100 (hardware processor) includes a central processing unit (CPU) 101, a read only memory (ROM) 102, and a random access memory (RAM) 103. The CPU 101 reads a program corresponding to the processing content from the ROM 102, loads the program to the RAM 103, and executes the loaded program to centrally control the operation of the components of the image forming apparatus 1 illustrated in FIG. 2. For example, when the amount of toner adhering to a collection roller 110 exceeds a predetermined amount, the controller 100 (hardware processor) executes a toner removal mode described below.

The image reader 10 includes an auto document feeder (ADF) 11 and a document image scanner 12 (scanner).

The auto document feeder 11 conveys a document D placed on a document tray using a conveyance mechanism, so as to feed the document D to the document image scanner 12. The auto document feeder 11 can successively read images (on one side or both sides) of a large number of documents D placed on the document tray in one batch.

The document image scanner 12 optically scans the document conveyed onto a contact glass from the auto document feeder 11 or a document placed on the contact glass. Then, the document image scanner 12 focuses the light reflected from the document onto a light receiving surface of a charge coupled device (CCD) sensor 12a so as to read the document image. The image reader 10 generates input image data based on the reading result by the document image scanner 12. The image processor 30 performs predetermined image processing on the input image data.

The operation display 20 includes, for example, a liquid crystal display (LCD) with a touch panel. The operation display 20 serves as a display 21 and an operation interface 22. The display 21 displays various operation screens, the image conditions, the operation status of various functions, and the like, according to a display control signal received from the controller 100 (hardware processor). The operation interface 22 includes various operation keys such as numeric keys and a start key. The operation interface 22 receives various input operations, and outputs an operation signal to the controller 100 (hardware processor).

The image processor 30 includes a circuit that performs digital image processing on image data of a job that is input (input image data) according to the initial settings or the user settings. For example, the image processor 30 performs tone correction based on tone correction data (tone correction table), under the control of the controller 100 (hardware processor). Also, the image processor 30 performs various correction processes such as color correction and shading correction, a compression process, and the like, on the input image data, in addition to the tone correction. The image former 40 is controlled based on the image data subjected to these processes.

The image former 40 includes image forming units 41Y, 41M, 41C, and 41K for forming images with colored toners respectively containing a Y component, an M component, a C component, and a K component, based on the image-processed input image data, and an intermediate transfer unit 42.

The image forming units 41Y, 41M, 41C, and 41K for the Y component, the M component, the C component, and the K component have the same configuration. For ease of illustration and description, common elements are denoted by the same reference signs. When the elements need to be distinguished from one another, Y, M, C, or K is added to the reference sign. In FIG. 1, only the elements of the image forming unit 41Y for the Y component are denoted by reference signs, and the elements of the other image forming units 41M, 41C, and 41K are not denoted by reference signs.

The image forming unit 41 includes an exposure device 411, a developing device 412, a photoconductor drum 413, a charging device 414, a drum cleaning device 415, and a collection mechanism 416. The developing device 412 serves as a developer, and the photoconductor drum 413 serves as an image carrier.

The photoconductor drum 413 is a negatively charged organic photoconductor (OPC) that includes an undercoat layer (UCL), a charge generation layer (CGL), and a charge transport layer (CTL) sequentially stacked on the peripheral surface of an aluminum conductive cylinder (aluminum element tube) of a drum diameter of 100 mm, for example.

The charge generation layer includes an organic semiconductor in which charge generation material (e.g., phthalocyanine pigment) is dispersed in a resin binder (e.g., polycarbonate). The charge generation layer generates a pair of positive charge and negative charge in response to exposure by the exposure device 411. The charge transport layer is formed by dispersing a positive hole transport material (electron donating nitrogen compound) in a resin binder (e.g., polycarbonate resin). The charge transport layer transports the positive charge generated by the charge generation layer to the surface of the charge transport layer.

The controller 100 (hardware processor) controls a driving current to be supplied to a driving motor (not illustrated) that rotates the photoconductor drum 413, thereby rotating the photoconductor drum 413 at a constant peripheral speed (e.g., 665 mm/sec).

The charging device 414 uniformly negatively charges the surface of the photoconductor drum 413. The exposure device 411 includes, for example, a semiconductor laser, and irradiates the photoconductor drum 413 with a laser beam for an image of the corresponding color component. A positive charge is generated in the charge generation layer of the photoconductor drum 413 and transported to the surface of the charge transport layer. As a result, a surface charge (negative charge) on the photoconductor drum 413 is neutralized. An electrostatic latent image of the corresponding color component is formed on the surface of the photoconductor drum 413 due to the potential difference from the surrounding area.

The developing device 412 is, for example, a two-component developing type developing device that uses a developing agent containing toner and carrier. The developing device 412 causes toner of the corresponding color component to adhere to the surface of the photoconductor drum 413, thereby visualizing an electrostatic latent image to form a toner image.

Specifically, the developing device 412 includes a developing sleeve 412a disposed to face the photoconductor drum 413 with a developing area interposed therebetween. The developing sleeve 412a has a diameter of, for example, 25 mm, and rotates at a peripheral speed of 665 mm/sec.

A developing bias obtained by superimposing an AC voltage on a DC voltage is applied to the developing sleeve 412a. In response to this, toner is frictionally charged, so that the toner is electrostatically adheres to the carrier. The developing bias may have a DC voltage of 200 to 800 V, an AC voltage with a peak-to-peak voltage (Vpp) of 800 V, and a square waveform at a frequency of 10 kHz, for example.

A developing magnet roller having magnetic poles is disposed inside the developing sleeve 412a. A magnetic field produced by the developing magnet roller generates a magnetic brush on the outer peripheral surface of the developing sleeve 412a, so that a layer of the developing agent is formed on the outer peripheral surface of the developing sleeve 412a. Then, the developing sleeve 412a rotates in a counterclockwise direction in FIG. 1, thereby conveying the developing agent to the developing area closest to the photoconductor drum 413 while carrying the developing agent on the outer peripheral surface of the developing sleeve 412a by way of the magnetic field. In the developing area, toner is electrostatically transferred from the developing sleeve 412a to the electrostatic latent image formed on the surface of the photoconductor drum 413. The carrier used herein is not particularly limited, and any common well-known carrier may be used. For example, binder-type carrier and a coat-type carrier may be used. The diameter of carrier particles may preferably be, but no limited to, 15 to 100 μm, and may be 33 μm, for example. The toner used herein is not particularly limited, and any common well-known toner may be used. For example, toner containing colorant and, if needed, a charge controlling anent and a release agent in binder resin and having an external additive added thereto may be used. The diameter of toner particles may preferably be, but no limited to, 3 to 15 μm, and may be 6 μm, for example.

The drum cleaning device 415 includes a drum cleaning blade that is brought into sliding contact with the surface of the photoconductor drum 413. The drum cleaning device 415 removes transfer residual toner remaining on the surface of the photoconductor drum 413 after primary transfer.

The collection mechanism 416 is disposed on the downstream side of the developing device 412, and on the upstream side of a primary transfer nip formed by a primary transfer roller 422 and the photoconductor drum 413, in the rotational direction of the photoconductor drum 413. The collection mechanism 416 collects carrier adhering to the photoconductor drum 413 from the developing device 412, before the carrier reaches the primary transfer nip.

The collection mechanism 416 will be described in detail below.

The intermediate transfer unit 42 includes the intermediate transfer belt 421, the primary transfer roller 422, a plurality of support rollers 423, a secondary transfer roller 424, and a belt cleaning device 426. The primary transfer roller 422 serves as a transferor.

The intermediate transfer belt 421 is formed of an endless belt, and is stretched in a loop shape around the plurality of support rollers 423. At least one of the plurality of support rollers 423 is a driving roller, and the others are driven rollers. For example, a roller 423A disposed on the downstream side of the primary transfer roller 422 for K component in the belt traveling direction is preferably a driving roller. This facilitates maintaining the belt traveling speed of the belt in the primary transfer section constant. As the driving roller 423A rotates, the intermediate transfer belt 421 travels in the direction of the arrow A at a constant speed.

The primary transfer roller 422 is disposed on the inner peripheral surface side of the intermediate transfer belt 421 so as to face the photoconductor drum 413 of the corresponding color component. The primary transfer roller 422 is pressed against the photoconductor drum 413 with the intermediate transfer belt 421 interposed therebetween, so that the primary transfer nip is formed to transfer the toner image from the photoconductor drum 413 to the intermediate transfer belt 421.

The secondary transfer roller 424 is disposed on the outer peripheral surface side of the intermediate transfer belt 421 so as to face a roller 423B (hereinafter referred to as a “backup roller 423B”) disposed on the downstream side of the driving roller 423A in the belt traveling direction. The secondary transfer roller 424 is pressed against the backup roller 423B with the intermediate transfer belt 421 interposed therebetween, so that a secondary transfer nip is formed to transfer the toner image from the intermediate transfer belt 421 to the sheet S.

When the intermediate transfer belt 421 passes through the primary transfer nips, the toner images on the photoconductor drums 413 are sequentially primary-transferred onto the intermediate transfer belt 421 in a superimposed manner. Specifically, a primary transfer bias is applied to each primary transfer roller 422, and a charge with a polarity opposite to that of toner is imparted to the back side of the intermediate transfer belt 421 (the side in contact with the primary transfer roller 422), so that the toner image is electrostatically transferred onto the intermediate transfer belt 421.

Thereafter, when the sheet S passes through the secondary transfer nip, the toner image on the intermediate transfer belt 421 is secondary-transferred onto the sheet S. Specifically, a secondary transfer bias is applied to the secondary transfer roller 424, and a charge with a polarity opposite to that of toner is imparted to the back side of the sheet S (the side in contact with the secondary transfer roller 424), so that the toner image is electrostatically transferred onto the sheet S. The sheet S with the toner image transferred thereon is conveyed toward the fixer 60.

The belt cleaning device 426 includes a belt cleaning blade that is brought into sliding contact with the surface of the intermediate transfer belt 421. The belt cleaning device 426 removes transfer residual toner remaining on the surface of the intermediate transfer belt 421 after secondary transfer. Note that in place of the secondary transfer roller 424, a configuration (so-called belt-type secondary transfer unit) in which a secondary transfer belt is stretched in a loop shape around a plurality of support rollers including a secondary transfer roller may be employed.

The fixer 60 applies, at a fixing nip, heat and pressure to the sheet S that has been conveyed with the toner image secondary-transferred thereon, thereby fixing the toner image on the sheet S.

The conveyer 50 includes a sheet feeder 51, a sheet discharger 52, and a conveyance path 53. Three sheet feeding tray units 51a to 51c included in the sheet feeder 51 store the sheets S identified based on the basis weight, size, or the like, according to the type that is set in advance. The sheet S may be any of a wide variety of sheets, including not only paper sheets such as standard sheets and special sheets, but also resin sheets and sheets with a resin-coated surface. In the present embodiment, the sheet S is a paper sheet. The conveyance path 53 includes a plurality of pairs of conveyance rollers such as a pair of registration rollers 53a.

The sheets S stored in the sheet feeding tray units 51a to 51c are sent out one by one from the uppermost portion, and conveyed to the image former 40 through the conveyance path 53. In this step, a registration roller unit including the pair of registration rollers 53a corrects the skew of the sheet S fed thereto, and adjusts the conveyance timing. Then, the image former 40 collectively secondary-transfers the toner images on the intermediate transfer belt 421 onto one side of the sheet S, and the fixer 60 performs a fixing process. The sheet S with an image formed thereon is discharged out of the image forming apparatus 1 by the sheet discharger 52 having discharge rollers 52a.

The sheet S may be long paper or rolled paper. In this case, the sheet S is stored in a sheet feeder (not illustrated) connected to the image forming apparatus 1, so that the sheet S stored in the sheet feeder is supplied from the sheet feeder to the image forming apparatus 1 via a sheet feeding opening 54, and sent to the conveyance path 53.

The storage 70 includes, for example, a non-volatile semiconductor memory (so-called flash memory), and a hard disk drive. The storage 70 stores various types of data such as various types of setting information about the image forming apparatus 1. The storage 70 also stores a program for executing the toner removal mode described below.

The communicator 80 includes a communication control card such as a local area network (LAN) card. The communicator 80 exchanges various types of data with external devices (for example, personal computers) connected to a communication network such as a LAN and a wide area network (WAN).

Configuration of Collecting Mechanism

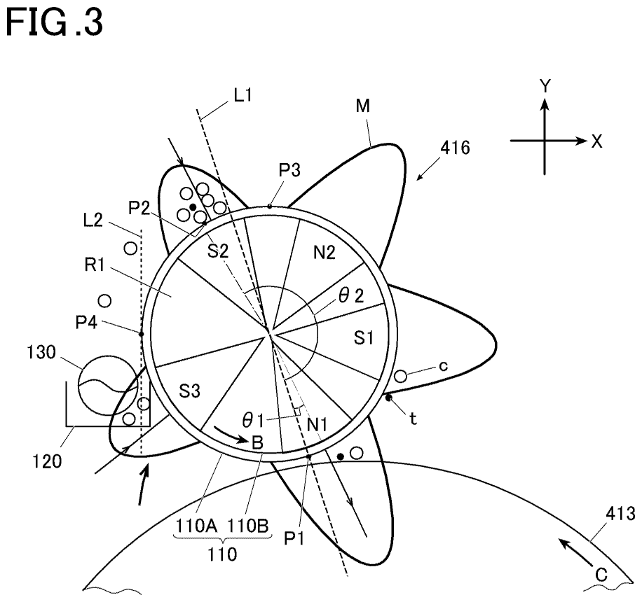

In the following, the configuration of the collection mechanism 416 will be described in detail with reference to FIG. 3.

The collection mechanism 416 is a mechanism for collecting the carrier on the surface of the photoconductor drum 413. As illustrated in FIG. 3, the collection mechanism includes the collection roller 110, a carrier collection chamber 120, a discharge screw 130, and a voltage applicator 140 (see FIG. 2).

Note that the direction indicated by X in FIG. 3 is the horizontal direction, and the direction indicated by Y in FIG. 3 is the vertical direction.

The collection roller 110 has an axis parallel to the axis of the photoconductor drum 413, and is disposed close to the photoconductor drum 413. The collection roller 110 includes a rotatable non-magnetic collection sleeve 110A having a thickness of, for example, 0.3 mm, and a collection magnet roller 110B fixed inside the collection sleeve 110A and having a diameter of, for example, 25 mm.

The collection sleeve 110A serves as a non-magnetic rotor of the present invention, and the collection magnet roller 110B serves as a magnet of the present invention.

The collection sleeve 110A is rotationally driven by a motor 150 in a direction B in FIG. 3. The collection sleeve 110A counter-rotates at the position facing the photoconductor drum 413 that rotates in a direction C in FIG. 3, such that its surface moves in the opposite direction to that of the photoconductor drum 413. The peripheral speed of the collection sleeve 110A for image formation is not particularly limited, and may be set to, for example, 293 mm/sec. There is a clearance between the collection sleeve 110A and the surface of the photoconductor drum 413.

The collection magnet roller 110B includes a plurality of magnetic poles (N1, N2, S1, S2, and S3) that generate a magnetic field. As illustrated in FIG. 3, the plurality of magnetic poles (N1, N2, S1, S2, and S3) are disposed such that N poles and S poles are alternately arranged. In FIG. 3, M indicates the distribution of the magnetic flux in the vicinity of the collection roller 110 generated by these magnetic poles. The magnetic poles N1, N2, and S1 are each configured to have a greater magnetic force than the magnetic poles S2 and S3.

The collection roller 110 is connected to the voltage applicator 140 such that a voltage obtained by superimposing an AC voltage on a DC voltage is applied thereto. The conditions of the applied voltage are not particularly limited, and the applied voltage may have, for example, a DC voltage of 0 to 800 V, an AC voltage with a difference between the maximum voltage and the minimum voltage, that is, Vpp of 800 to 2,000 V, and a square waveform at a frequency of 500 to 2,000 Hz. That is, the carrier c collected on the surface of the collection roller 110 is caused to adhere to the outer peripheral surface of the collection sleeve 110A, by the magnetic force generated by the magnetic poles disposed in the collection magnet roller 110B and the electrostatic force of the electric field generated by the applied voltage. The carrier adhering to the collection sleeve 110A is conveyed on the surface of the collection roller 110 as the collection sleeve 110A rotates in the direction indicated by B in FIG. 3.

The following describes a carrier conveyance operation of the collection roller 110 in detail.

The collection magnet roller 110B has a magnetic pole N1 such that the magnetic pole N1 generally faces the photoconductor drum 413. The magnetic pole N1 is the most powerful magnetic pole among the magnetic poles disposed in the collection magnet roller 110B, and serves as a collection pole that collects the carrier c from the surface of the photoconductor drum 413. That is, the carrier c on the surface of the photoconductor drum 413 is attracted to the surface of the collection sleeve 110A and collected by the magnetic force generated by the magnetic pole N1. The magnetic flux density of the collection pole N1 is not particularly limited, and may be, for example, 150 mT.

Also, as illustrated in FIG. 3, when a counterclockwise angle with respect to a center line L1 connecting the center of the collection roller 110 and the photoconductor drum 413 is defined as θ, the collection pole N1 is disposed such that its peak position satisfies θ1=0 to 10°, that is, at a position slightly shifted from a closest position P1 where the photoconductor drum 413 and the collection roller 110 are closest to each other. With this arrangement, the carrier easily adheres to the collection sleeve 110A counter-rotating with respect to the photoconductor drum 413.

In the collection magnet roller 110B, the magnetic pole S1 and the magnetic pole N2 are disposed in this order from the magnetic pole N1 toward the downstream side in the rotational direction of the collection sleeve 110A such that the N pole and the S pole are alternately arranged. These magnetic poles serve as conveyance poles that convey the carrier c along the surface of the collection sleeve 110A. The carrier c receives the magnetic force generated by these poles, and rotates and moves on the surface of the collection sleeve 110A.

The magnetic pole S2 is disposed on the downstream side of the magnetic pole N2 in the rotational direction of the collection sleeve 110A. The magnetic pole S2 serves as a separation pole that separates the collected carrier c from the collection sleeve 110A. That is, when the carrier c reaches a region (separation pole section P2), indicated by P2 in FIG. 3, on the collection sleeve 110A in contact with the magnetic pole S2, the carrier c cannot move further downstream. Therefore, the carrier c remains at the separation pole section P2 while being rotated by the magnetic attractive force of the separation pole S2, and rubs the surface of the collection sleeve 110A while involving the carrier c that has newly reached the separation pole section P2 due to the rotation of the collection sleeve 110A.

When a counterclockwise angle with respect to the line L1 in FIG. 3 is defined as θ, the separation pole S2 is disposed such that its peak position satisfies, for example, θ2=200°. If the separation pole S2 is disposed on the upstream side in the rotational direction of the collection sleeve 110A with respect to a highest position P3 of the collection sleeve 110A in the vertical direction indicated by Y in FIG. 3, the efficiency at which the carrier collection chamber 120 collects the carrier separated from the separation pole S2 is reduced. On the other hand, if the separation pole S2 is disposed on the downstream side in the rotational direction of the collection sleeve 110A with respect to a most projecting position P4 of the collection sleeve 110A in the horizontal direction indicated by X in FIG. 3, the carrier is less easily separated from the separation pole S2. Therefore, the carrier may be carried to the closest position P1 to the photoconductor drum 413 as the collection roller 110 rotates, and adhere again to the photoconductor drum 413. Accordingly, the separation pole S2 is preferably disposed on the downstream side of the position P3 and on the upstream side of the position P4 in the rotational direction of the collection sleeve 110A.

As mentioned above, the separation pole S2 has a smaller magnetic force than the collection pole N1 and the conveyance poles S1 and N2. Therefore, the carrier is easily separated when the amount of carrier staying at the separation pole section P2 exceeds a predetermined amount. The magnetic flux density of the separation pole S2 is not particularly limited, and may be, for example, 70 mT.

The magnetic pole S3 is disposed on the downstream side of the magnetic pole S2 in the rotational direction of the collection sleeve 110A. The magnetic pole S3 serves as a sealing pole, and forms a repulsive magnetic field with the separation pole S2.

A demagnetization area R1 is formed on the downstream side of the separation pole S2 and the upstream side of the sealing pole S3 in the rotational direction of the collection sleeve 110A. Although the separation pole S2 and the sealing pole S3 have the same polarity and hence form a repulsive field, the demagnetization area R1 is disposed therebetween. Therefore, no magnetic field is formed in the area on the downstream side of the separation pole S2 and on the upstream side of the sealing pole S3, and no magnetic force acts thereon. Accordingly, the carrier c separated from the separation pole P2 falls into the carrier collection chamber 120 without adhering again to the collection sleeve 110A.

The carrier collection chamber 120 is disposed in the vicinity of the collection roller 110, and collects the carrier that has fallen from the collection sleeve 110A.

The discharge screw 130, which is a helical screw member, is disposed inside the carrier collection chamber 120. The carrier c collected in the carrier collection chamber 120 is discharged into a carrier collection box (not illustrated) by the discharge screw 130 so as to be discarded.

The number of conveyance poles disposed in the collection magnet roller 110B in the present embodiment is merely an example. The number of conveyance poles is not limited thereto as long as N poles and S poles are alternately arranged.

Removing Toner on Collection Roller

The following describes a method of removing toner adhering to the collection roller 110.

As mentioned above, the collection roller 110 applies a voltage such that the negatively charged carrier on the surface of the photoconductor drum 413 is easily collected at the closest position P1.

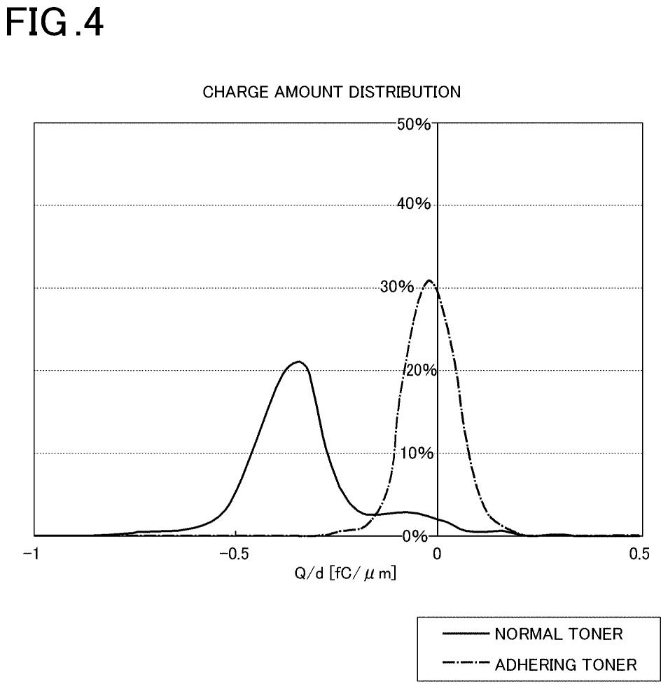

In this step, the collection roller 110 also collects so-called fogging toner adhering to the surface of the photoconductor drum 413. FIG. 4 illustrates the charge amount of toner. As illustrated in FIG. 4, the toner inside the developing device 412 (normal toner) is negatively charged. On the other hand, most of the toner adhering to the collection roller 110 (adhering toner) is weakly charged/reversely charged toner around zero charge with no charge. Such toner adheres to the background of the image as fogging toner. Normally-charged toner adheres to the photoconductor drum 413 due to the electrostatic force. Whereas, the adhesion of weakly charged toner and reversely charged toner to the photoconductor drum 413 due to the electrostatic force is weak, so that the toner is transferred to the collection roller 110, at the closest position P1 where the collection roller 110 and the photoconductor drum 413 are closest to each other, as illustrated in FIG. 3.

Since the toner t is a non-magnetic material, the toner t transferred to the collection roller 110 moves while being fixed to the surface of the collection sleeve 110A without being affected by the magnetic force generated by the magnetic poles of the collection magnet roller 110B. When the toner t reaches the separation pole section P2, the toner is rubbed by the carrier c staying at the separation pole section P2, accumulates together with the carrier c, and is eventually collected into the carrier collection chamber 120.

However, when there is not a sufficient amount of carrier on the collection sleeve 110A, there is not enough carrier at the separation pole section P2 to sufficiently collect the toner at the separation pole section P2. In this case, toner accumulates on the collection sleeve 110A, and the toner on the collection sleeve 110A fills up the clearance between the photoconductor drum 413 and the collection roller 110. Then, the toner on the collection roller 110 adheres again to the photoconductor drum 413, and is transferred to the sheet S, resulting in image noise.

In view of the above, in the present embodiment, the toner adhering to the collection sleeve 110A is electrically returned to the surface of the photoconductor drum 413, thereby removing the toner on the collection sleeve 110A. A study (described below) by the inventors revealed that, the toner removal efficiency is affected by at least (1) the voltage applied to the collection roller 110, and (2) the peripheral speeds of the collection sleeve 110A and the photoconductor drum 413.

(1) Voltage Applied to Collection Roller

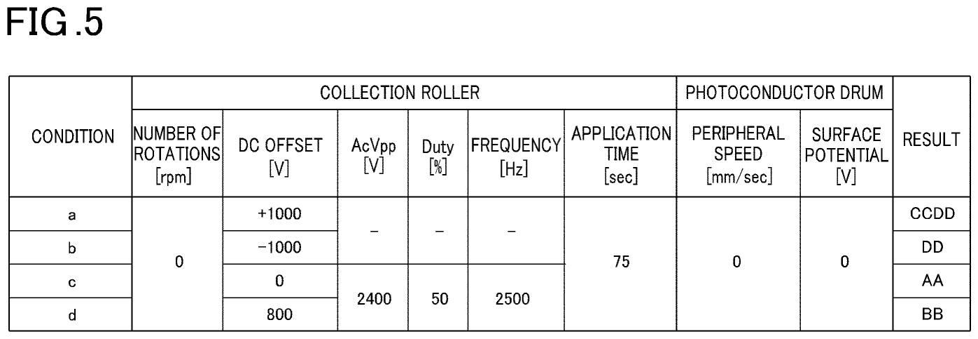

As illustrated in FIG. 5, a predetermined image was printed on a predetermined number of sheets S while varying the voltage applied to the photoconductor drum 413. Thereafter, the amount of toner adhering to the collection roller 110 was visually observed. Also, the toner on the collection roller 110 was collected using a mending tape, and then the reflection density of the mending tape was measured to determine whether the reflection density is in the range of a predetermined target value.

In FIG. 5, the column “RESULT” indicates the result of evaluating the amount of toner adhering to the collection roller by visual observation and measurement of the reflection density. The symbol “AA” indicates that there is no adhering toner; “BB” indicates that the reflection density is within the range of the target value although toner adhesion is visually observed; “CC” indicates that deposition of toner on the collection roller 110 is not visually confirmed; and “DD” indicates that deposition of toner on the surface of the collection roller 110 is visually confirmed.

In FIG. 5, under a condition a, when a positive DC voltage was applied to the collection roller 110, about one-tenth the toner on the collection roller 110 was transferred to the photoconductor drum 413. Under a condition b, when a negative DC voltage was applied to the collection roller 110, no toner was transferred. On the other hand, under a condition c, when only an AC voltage was applied to the collection roller 110, toner vibrated in a predetermined area in the vicinity of the closest position P1, so that about 50% of the toner was transferred to the photoconductor drum 413. Under a condition d, when a voltage obtained by superimposing a DC voltage on an AC voltage was applied, the amount of toner transferred was less compared to the case where only an AC voltage was applied. It seems that toner was transferred only at the closest position P1.

That is, to improve the toner removal efficiency, it is preferable to apply only an AC voltage to the collection roller 110. Also, the toner removal efficiency may be improved when a potential difference is set less than the potential difference between a surface potential of the photoconductor drum 413 (e.g., 600 V) and a DC voltage applied to the collection roller 110 (e.g., 300 V).

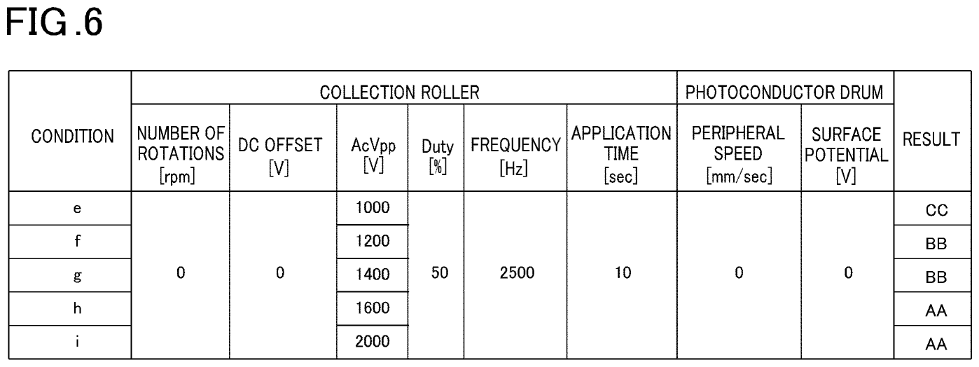

Subsequently, as illustrated in FIG. 6, under the condition where only an AC voltage was applied, a predetermined image was printed on a predetermined number of sheets S while varying the Vpp value of the AC voltage. Then, in the same manner as in FIG. 5, the amount of toner adhering to the collection roller 110 was evaluated.

The results of conditions h and i in FIG. 6 indicated that, as the Vpp value of the AC voltage is increased, the amount of toner transferred to the photoconductor drum 413 is increased. Also, as will be described below in detail, since toner moves in the rotational direction of the collection roller 110 while vibrating between the collection roller 110 and the photoconductor drum 413, the toner is more likely to be transferred to the photoconductor drum 413 as the moving distance of toner is increased and as the time during which the toner stays between the collection roller 110 and the photoconductor drum 413 is increased. The moving distance of toner was 2 mm under conditions e and f, 3 mm under a condition g, and 4 mm under the conditions h and i. This revealed that, in terms of the moving distance of toner as well, an AC voltage with a higher Vpp value is more advantageous.

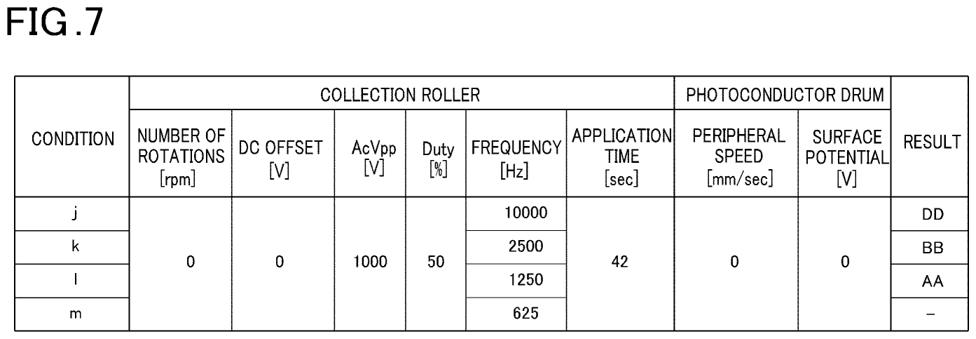

Subsequently, as illustrated in FIG. 7, under the condition where only an AC voltage was applied, a predetermined image was printed on a predetermined number of sheets S while varying the frequency of the AC voltage. Then, in the same manner as in FIG. 5, the amount of toner adhering to the collection roller 110 was evaluated.

The result of a condition j indicated that increasing the frequency is not effective in transferring toner. Whereas, the result of a condition 1 indicated that the greatest effect is achieved when the frequency is 1,250 Hz, and the result of a condition m indicated that the amount of toner transferred is reduced when the frequency is further reduced. The moving distance of toner was 2 mm under a condition k, 4 mm under the condition 1, and 1 mm under the condition m. This revealed that, in terms of the moving distance of toner as well, an advantages effect is achieved when the frequency is 1,250 Hz. That is, this revealed that there is an appropriate value for the frequency of the AC voltage.

(2) Peripheral Speeds of Collection Roller and Photoconductor Drum

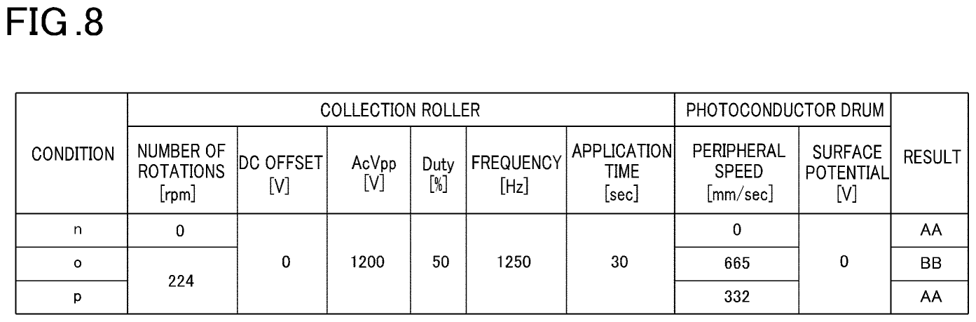

As illustrated in FIG. 8, a predetermined image was printed on a predetermined number of sheets S while varying the peripheral speeds of the photoconductor drum 413 and the collection roller 110 by controlling their number of rotations. Then, in the same manner as in FIG. 5, the amount of toner adhering to the collection roller 110 was evaluated.

The results revealed that, under conditions n and p in FIG. 8, the amount of toner transferred to the photoconductor drum 413 is increased by reducing the peripheral speed of at least one of the photoconductor drum 413 and the collection roller 110. Accordingly, the amount of toner transferred may be increased by increasing the time during which the toner stays in the vicinity of the closest position P1 between the photoconductor drum 413 and the collection roller 110 while vibrating.

It was also found from the comparison between the conditions n and p that the toner removal efficiency can be further improved by setting the peripheral speed of the photoconductor drum 413 to half the peripheral speed for image formation (665 mm/sec) or less.

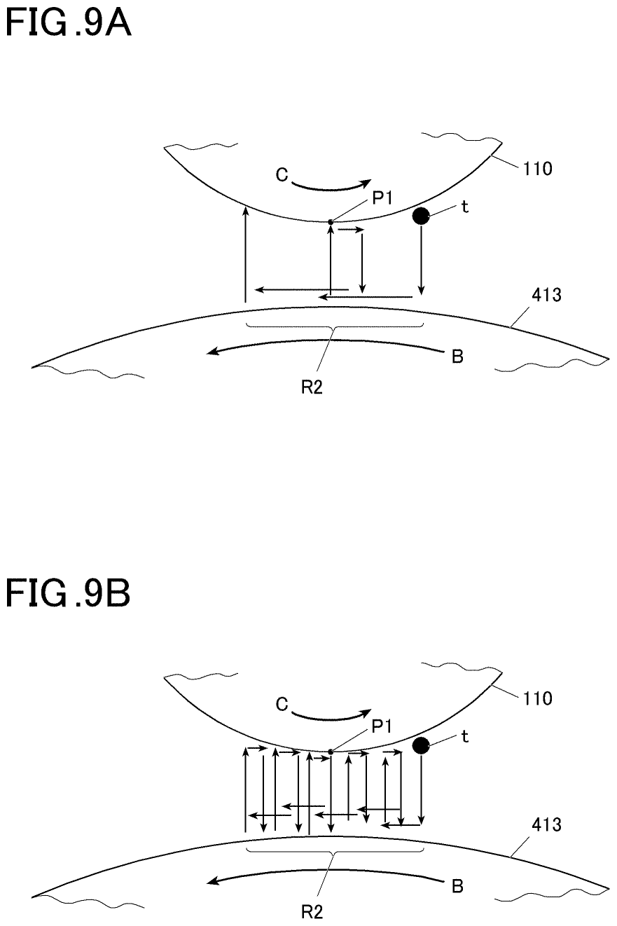

The expected mechanism in this case will be described in detail with reference to FIGS. 9A and 9B.

FIG. 9A illustrates the movement model of toner expected when the photoconductor drum 413 and the collection roller 110 rotate at peripheral speeds for image formation. The peripheral speed of the collection roller 110 is set to, for example, 293 mm/s, and the peripheral speed of the photoconductor drum 413 is set to, for example, 665 mm/s. Then, a voltage is applied to the collection roller 110 under conditions where the amount of toner transferred is increased as illustrated in FIGS. 5 to 7. Specifically, a voltage is applied with a DC voltage of 0V, an AC voltage with Vpp of 1,600 V, and a frequency of 1,250 Hz, thereby setting the surface potential of the photoconductor drum 413 to 0 V.

FIG. 9B illustrates the movement model of toner expected when the peripheral speed of the photoconductor drum 413 is less than that in FIG. 9A and the other conditions are the same as those in FIG. 9A.

As indicated by the arrows in FIGS. 9A and 9B, toner adhering to the collection roller 110 reciprocates in the gap, that is, vibrates to reciprocate between the surface of the photoconductor drum 413 and the surface of the collection roller 110 in a close area R2, in response to the AC voltage applied to the collection roller 110. Note that the close area R2 is an area which includes the closest position P1 and in which the photoconductor drum 413 and the collection roller 110 are closest to each other.

In the model of FIG. 9A, compared to the model of FIG. 9B, the peripheral speed of the photoconductor drum 413 is higher, and the vibration frequency of the toner tin the close area R2 is lower. Accordingly, the time during which the toner t stays in the close area R2 is reduced. On the other hand, as illustrated in FIG. 9B, as the peripheral speed of the photoconductor drum 413 is reduced, the vibration frequency of the toner tin the close area R2 increases, so that the stay time of the toner t increases. As the stay time of the toner t in the close area R2 increases, the toner t gathers on the surface of the photoconductor drum 413 while repeatedly vibrating.

The toner gathers on the photoconductor drum 413 instead of gathering on the collection roller 110 as a result of the reciprocating motion in the gap. A possible reason for this is as follows.

When the toner is electrically charged, a conductor surface, that is, the surface of the collection roller 110 having a higher image force than the surface of the photoconductor drum 413 has a higher toner holding force. However, the toner adhering to the collection roller is weakly charged or reversely charged toner around zero charge. Therefore, the non-electrostatic adhesion force is dominant over the electrostatic adhesion force. Generally, an object with a lower surface hardness has a higher surface adsorption force. Accordingly, toner adheres more easily to the photoconductor drum 413 having a resin-coated surface, than to the collection roller 110 having a surface made of a pure metallic material. As a result, the toner is transferred to the surface of the photoconductor drum 413.

In FIG. 9B, the peripheral speed of the photoconductor drum 413 is reduced. However, the stay time of toner in the close area R2 can be increased by reducing the peripheral speed of the collection roller 110 as well. Also, by reducing the peripheral speeds of both the photoconductor drum 413 and the collection roller 110, the stay time in the close area R2 can be further increased, and the efficiency of removing the toner on the collection roller 110 can be improved.

However, it is preferable to reduce the peripheral speed of the photoconductor drum 413. The rotation of the photoconductor drum 413 induces a reduction in the thickness of its surface layer, which reduces the service life thereof. For example, in the case of feeding A4-size sheets horizontally, the photoconductor drum 413 is durable up to feeding of 600 kp, whereas the collection roller 110 is durable up to feeding of 30,000,000 kp. That is, since the photoconductor drum 413 with a resin-coated surface has a much shorter service life than the collection roller 110 having a metal surface, it is advantageous in terms of the service life of parts to reduce the peripheral speed of the photoconductor drum 413 and thereby reduce the number of rotations.

In FIGS. 9A and 9B, the collection roller 110 is configured to counter-rotate with respect to the photoconductor drum 413. However, even if the collection roller 110 is configured to co-rotate with the photoconductor drum 413, the toner removal efficiency can be improved by reducing the peripheral speed of at least one of the photoconductor drum 413 and the collection roller 110.

Further, under the condition p of FIG. 8, if the voltage described above is applied while the rotation of both the photoconductor drum 413 and the collection roller 110 is stopped, all the toner on the surface of the collection roller 110 is transferred to the photoconductor drum 413. In the case where both the photoconductor drum 413 and the collection roller 110 are stopped, an electric field is locally applied for a sufficiently long time compared to the usual time taken to pass through the close area R2. Thus, the reciprocating motion of the toner tin the gap ends, so that the toner t is expected to gather on the surface of the photoconductor drum 413.

In this case, after transferring the toner while the rotation of the both is stopped, each is rotated by a width of the close area R2. Then, the rotation is stopped again, and the toner is removed by applying a voltage to the collection roller 110. That is, it is possible to reliably remove the toner on the collection roller 110 by repeating this operation until a point on the outer periphery of the collection roller 110 makes one turn and passes through the close area R2.

Toner Removal Mode

Based on the result of the study, the image forming apparatus 1 of the present embodiment executes a toner removal mode for removing toner adhering to the surface of the collection roller 110.

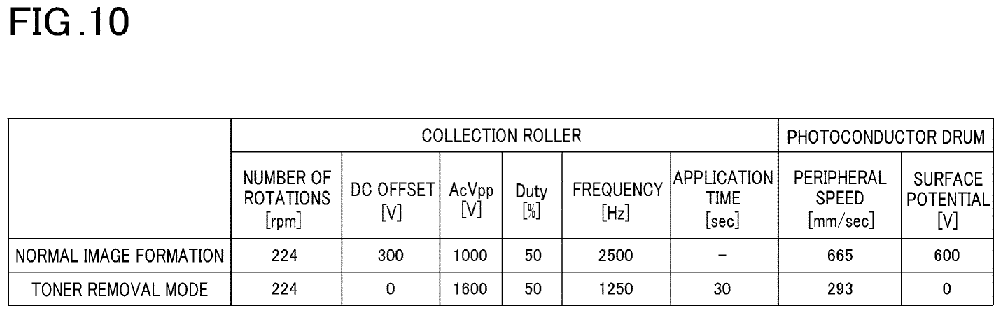

FIG. 10 illustrates the operating conditions of the collection roller 110 and the photoconductor drum 413 in the toner removal mode. In the toner removal mode, as illustrated in FIGS. 5 to 8, only an alternating voltage is applied to the collection roller 110; the Vpp of the AC voltage is set higher than that for image formation; and the frequency is set to 1,250 Hz at which a high removal efficiency can be achieved. Also, the peripheral speed of the photoconductor drum 413 is set less than that for image formation, and the surface potential is controlled to be 0 V.

To execute the toner removal mode for 30 seconds, the application time of a voltage to the carrier collection roller is set to 30 seconds.

The toner removal mode is executed when a substantial amount of toner is expected to be adhering to the surface of the collection roller 110.

The amount of toner adhering to the surface of the collection roller 110 is estimated in the following manner. The charge amount of toner is detected from the value of the current of the developing agent that flows when toner is developed by the developing device 412. If the detected charge amount of toner is lower than a predetermined threshold, a determination can be made that the charge amount is reduced and the toner is weakly charged/reversely charged. If printing is continued in this condition, a significant amount of fogging toner is likely to adhere to the surface of the collection roller 110. Accordingly, the toner removal mode is executed when a predetermined number of pages are printed after the charge amount of toner exceeds a predetermined threshold.

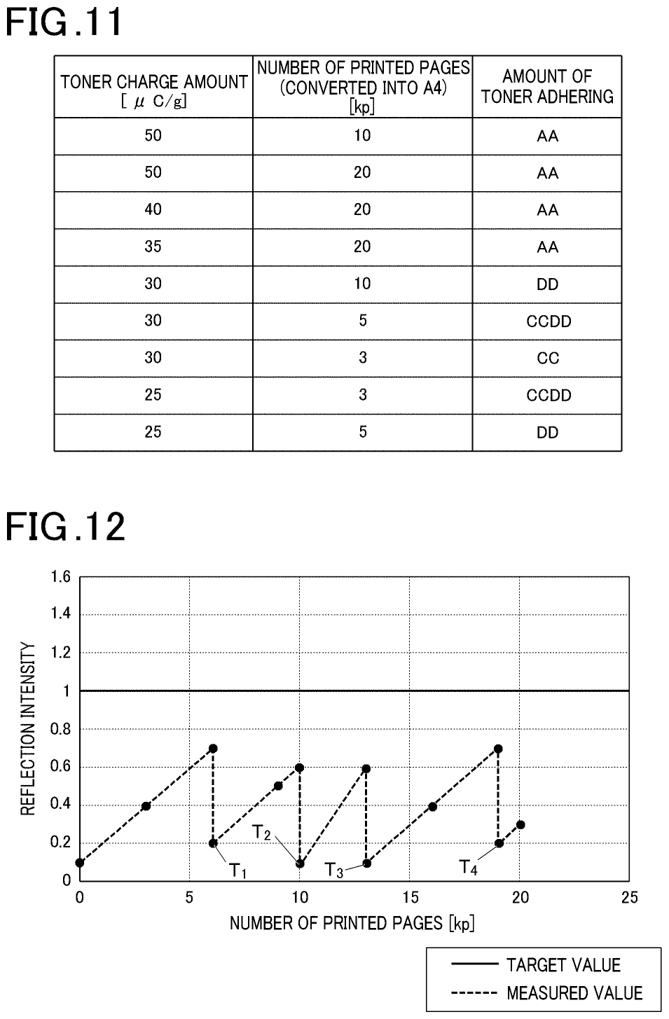

FIG. 11 illustrates the relationship between the detected charge amount of toner and the amount of the toner on the collection roller 110 that is observed after a predetermined number of pages printed under different conditions. The number of pages printed is obtained by converting the cumulative image area into the number of A4-size pages.

In FIG. 11, the column “AMOUNT OF TONER ADHERING” indicates the result of evaluating the amount of toner adhering to the collection roller on four levels, “AA”, “BB”, “CC”, and “DD”, by visual observation and measurement of the reflection density. The symbol “AA” indicates that there is no adhering toner; “BB” indicates that the reflection density is within the range of the target value although toner adhesion is visually observed; “CC” indicates that deposition of toner on the collection roller 110 is not visually confirmed; and “DD” indicates that deposition of toner on the surface of the collection roller 110 is visually confirmed.

As illustrated in FIG. 11, when the charge amount is 35 μC/g or greater, no adhesion of toner on the collection roller 110 is observed regardless of the number of pages printed, and therefore the charge amount is sufficient. Whereas, when the charge amount is 30 μC/g or less, toner starts to adhere to the collection roller 110 as printing is continued. When the charge amount is 30 μC/g, if 5 kp or more pages are continuously printed, toner starts to accumulate on the collection roller 110. If 3 kp are continuously printed, the reflection density reaches a range of 1.0 to 3.0 exceeding the target value range. Then, toner starts to adhere to the collection roller 110, but does not accumulate thereon.

Accordingly, if it is detected that the charge amount is 30 μC/g or less, the toner removal mode is executed every time 3 kp are printed, thereby the amount of toner on the collection roller 110 can be maintained equal to or less than the target value.

FIG. 12 illustrates changes in amount of toner adhering to the collection roller 110 in the case where the toner removal mode was executed every time 3 kp of A4 size was continuously printed with the charge amount of 30 μC/g or less. The reflection density was obtained by collecting the toner adhering to the collection roller 110 using a mending tape and measuring the reflection density of the mending tape. In FIG. 12, T1 to T4 represent the points in time when the toner removal mode was executed. The target value of the reflection density was set to 1.0. This is because image defects due to the toner on the collection roller 110 occur when the measured reflection density is 1.0 or greater.

As illustrated in FIG. 12, since the reflection density decreased every time the toner removal mode was executed, the effect of toner removal from the collection roller 110 by the toner removal mode was confirmed. The results indicated that the amount of toner adhering can be maintained equal to or less than the target value by periodically repeating the toner removal mode. Further, no image defects due to toner adhering to the surface of the collection roller 110 were found in the images formed on the sheets.

In the above description, the toner removal mode is executed based on the detected charge amount of the toner in the developing device 412 and the accumulated number of pages printed (image formation information). However, the disclosure is not limited thereto. A determination as to whether to execute the toner removal mode may be made based on various types of image formation information. For example, it is effective to execute the toner removal mode after printing is continued under the conditions where fogging toner is likely to be generated, such as under high coverage conditions and high-temperature high-humidity conditions.

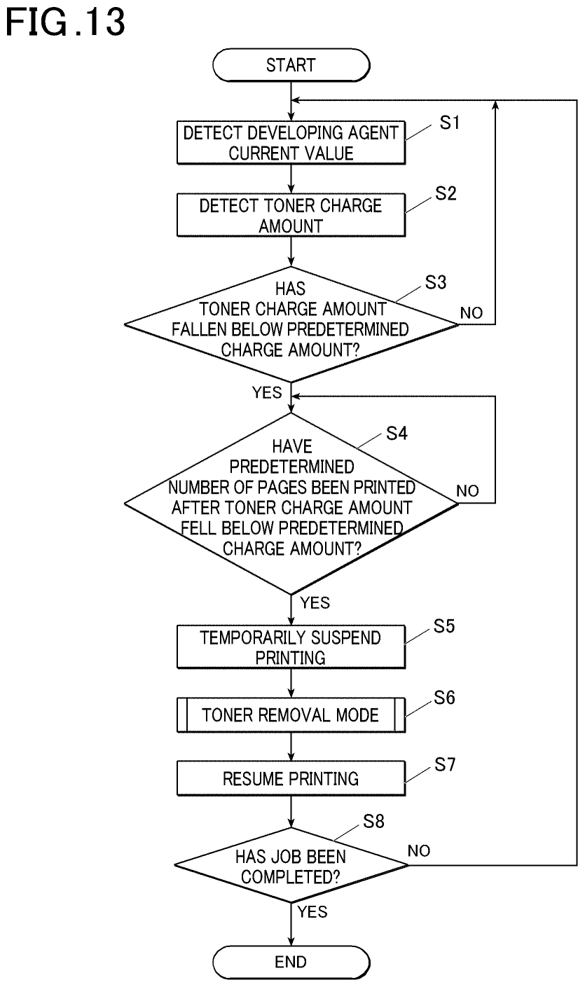

In the following, the operations of the image forming apparatus 1 of the present embodiment will be described with reference to the flowchart of FIG. 13. The process illustrated in FIG. 13 is executed by cooperation between the controller 100 (hardware processor) and a program stored in the storage 70.

When the image forming apparatus 1 starts a printing operation, the controller 100 (hardware processor) detects a developing agent current value in the developing device 412 (step S1). Then, the controller 100 (hardware processor) detects the charge amount of toner, based on the detected current value (step S2).

The controller 100 (hardware processor) determines whether the detected charge amount of toner has fallen below a predetermined charge amount that is set in advance (step S3). The predetermined charge amount may be stored in advance in the storage 70, or may be set to an arbitrary value selected by the user. If the charge amount of toner has not fallen below the predetermined charge amount (step S3: NO), the process returns to step S1. On the other hand, if the charge amount of toner has fallen below the predetermined charge amount (step S3: YES), the process proceeds to step S4.

In step S4, the controller 100 (hardware processor) determines whether a predetermined number of pages have been printed after detection that the charge amount of toner has fallen below the predetermined charge amount. As described above, the predetermined number of pages is the number of pages that can be printed continuously while maintaining the amount of toner adhering to the collection roller 110 in a range where no image defect occurs, when the charge amount of toner is set to a certain value. The predetermined number of pages is stored in advance in association with the predetermined charge amount used in step S3. If the predetermined number of pages have not been printed (step S4: NO), the process repeats step S4. If the predetermined number of pages have been printed (step S4: YES), the process proceeds to step S5.

In step S5, the controller 100 (hardware processor) temporarily suspends the printing operation. Then, the controller 100 (hardware processor) executes the toner removal mode (step S6).

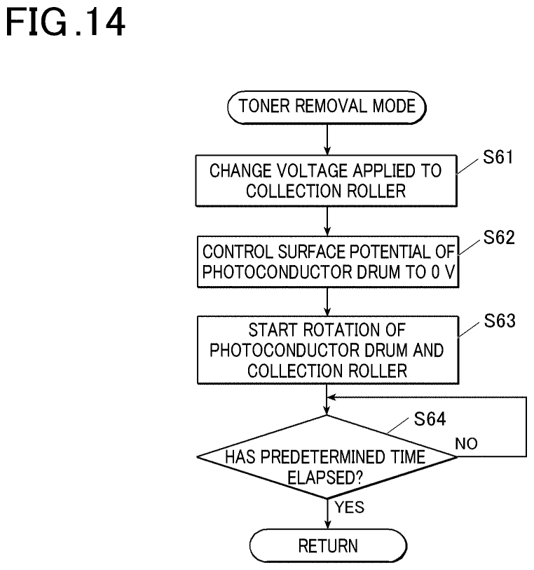

FIG. 14 is a flowchart illustrating the operations of the image forming apparatus 1 in the toner removal mode. The process illustrated in FIG. 14 is executed by cooperation between the controller 100 (hardware processor) and a program stored in the storage 70.

In the toner removal mode, the controller 100 (hardware processor) first changes the voltage applied to the collection roller 110 (step S61). Specifically, as described above, only an AC voltage is applied; the Vpp is set higher than that for image formation; and the frequency is set to a value suitable for toner removal.

Then, the controller 100 (hardware processor) controls the surface potential of the photoconductor drum 413 to 0 V (step S62). Specifically, the surface potential can be set to 0 V by discharging the surface of the photoconductor drum 413 using an eraser that is disposed in the vicinity of the photoconductor drum 413 and that includes an exposure unit such as an LED.

Then, the controller 100 (hardware processor) starts rotation of the photoconductor drum 413 and the collection roller 110 (step S63). As described above, the controller 100 (hardware processor) controls the peripheral speed of at least one of the photoconductor drum 413 and the collection roller 110 to less than that for image formation.

Note that steps S61 to S63 may be performed in a different order.

Then, the controller 100 (hardware processor) determines whether a predetermined time has elapsed (step S64). The predetermined time is a time that is set in advance as an execution time for the toner removal mode. If the predetermined time has elapsed (step S64: YES), the toner removal mode is ended. On the other hand, if the predetermined time has not elapsed (step S64: NO), step S64 is repeated.

When the toner removal mode is ended, the process returns to FIG. 13. The controller 100 (hardware processor) resumes printing (step S7). In this step, the operating conditions of the photoconductor drum 413 and the collection roller 110 are set back to those for image formation.

Then, the controller 100 (hardware processor) determines whether a job has been completed (step S8). If the job has been completed, that is, printing of a predetermined number of pages has been completed (step S8: YES), the control is ended. On the other hand, if printing has not been completed (step S8: NO), the process returns to step S1, and the above operations are repeated.

### ADVANTAGEOUS EFFECTS

As described above, the image forming apparatus 1 according to the present embodiment includes the collection mechanism 416 that collects carrier from the surface of the photoconductor drum 413 by the action of an electric field and a magnetic field. In the toner removal mode for removing toner adhering to the collection roller 110, the peripheral speed of at least one of the photoconductor drum 413 and the collection roller 110 is set less than that for image formation. This makes it possible to secure a sufficient time for toner to vibrate between the collection roller 110 and the photoconductor drum 413, and to efficiently transfer the toner to the photoconductor drum 413.

Further, in the toner removal mode, wear of the photoconductor drum 413 can be reduced by reducing the peripheral speed of the photoconductor drum 413.

Further, in the toner removal mode, the toner removal efficiency can be increased by controlling the voltage that is applied to the collection roller 110.

Moreover, the removal efficiency can be further improved by setting the peripheral speed of at least one of the photoconductor drum 413 and the collection roller 110 to half the peripheral speed for image formation or less.

Moreover, the removal efficiency can be further improved by stopping at least one of the photoconductor drum 413 and the collection roller 110.

Further, the amount of toner adhering to the collection roller 110 is determined based on the charge amount of toner in the developing device 412. Thus, when the amount of toner adhering becomes less than the predetermined amount of toner adhering, the toner removal mode is executed. In this manner, it is possible to accurately determine the condition that requires toner removal, and effectively prevent image defects.

Also, when a predetermined number of pages are continuously printed under a condition where the charge amount is low, the toner removal mode is executed. In this manner as well, it is possible to accurately determine the condition that requires toner removal, and effectively prevent image defects.

### Other Embodiments

Although a specific embodiment of the present invention has been described, the above embodiment is merely a preferred embodiment of the present invention, and does not limit the scope of the present invention.

For example, in the above embodiment, the collection roller is configured to remove the carrier retained at the separation pole. However, a scraper may be brought into contact with the surface of the collection roller to scrape off and remove the carrier adhering to the collection roller. That is, as long as the collection mechanism collects the carrier on the photoconductor drum by the action of an electric field and a magnetic field, the details of the configuration may be appropriately modified.

In the above description, a non-volatile memory, a hard disk, or the like is used as a computer-readable medium storing the program according to the present invention. However, the present invention is not limited thereto. Portable recording media such as a CD-ROM are applicable as other computer-readable media. Carrier wave is also applicable as a medium for providing data of the program according to the present invention through a communication line.

Other changes and modifications may also be made to the configuration and operation of the devices included in the image forming apparatus without departing from the scope of the present invention.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
an image carrier that carries a toner image to be transferred to a sheet;
a developer that develops a toner image on the image carrier, with a two-component developing agent containing toner and carrier;
a transferor that transfers the toner image being carried by the image carrier;
a collection mechanism that is disposed on a downstream side of the developer and on an upstream side of the transferor, and collects the carrier on a surface of the image carrier by a magnetic force and an electrostatic force; and
a hardware processor that controls removal of the toner adhering to the collection mechanism;
wherein the collection mechanism includes a collection roller that incorporates a magnet and that is rotatable about an axis parallel to an axis of the image carrier while facing the image carrier, and a voltage applicator that applies a voltage to the collection roller; and
wherein the hardware processor performs a toner removal mode to remove the toner from a surface of the collection roller, by setting a peripheral speed of at least one of the image carrier and the collection roller to less than a peripheral speed thereof for image formation.

2. The image forming apparatus according to claim 1, wherein the collection roller includes the magnet that faces the image carrier and extends in parallel to the axis of the image carrier, and a non-magnetic rotor that is disposed on a peripheral surface of the magnet and is rotatable independently of the magnet.

3. The image forming apparatus according to claim 1, wherein in the toner removal mode, the hardware processor controls the peripheral speed of the image carrier to less than a peripheral speed thereof for image formation.

4. The image forming apparatus according to claim 1, wherein in the toner removal mode, the hardware processor controls a difference between a maximum voltage and a minimum voltage of an AC voltage that is applied by the voltage applicator to less than a difference for image formation.

5. The image forming apparatus according to claim 1, wherein in the toner removal mode, the hardware processor controls a potential difference between a value of a DC voltage that is applied by the voltage applicator and a surface potential of the image carrier to less than a potential difference for image formation.

6. The image forming apparatus according to claim 1, wherein in the toner removal mode, the hardware processor controls the peripheral speed of at least one of the image carrier and the collection roller to half the peripheral speed thereof for image formation or less.

7. The image forming apparatus according to claim 1, wherein in the toner removal mode, the hardware processor stops rotation of at least one of the image carrier and the collection roller.

8. The image forming apparatus according to claim 1, wherein the hardware processor detects an amount of toner adhering to the surface of the collection roller based on a charge amount of toner inside the developer, and executes the toner removal mode when the amount of toner adhering exceeds a predetermined amount.

9. The image forming apparatus according to claim 1, wherein the hardware processor detects an amount of toner adhering to the surface of the collection roller based on image formation information about previously performed image formation, and executes the toner removal mode when the amount of toner adhering exceeds a predetermined amount.
